(19) United States
(12) Patent Application Publication
(10) Pub. No.: US 2002/0030428 A1
(43) Pub. Date: Mar. 14, 2002

(54) Plastic cap for compact fluorescent lamps

(76) Inventors: Erzsebet Cserteg, Budapest (HU); Jozsef Fulop, Budapest (HU); Jozsef Tokes, Budapest (HU); Istvan Wursching, Budapest (HU)

Correspondence Address: Timothy E. Nauman, FAY, SHARPE, FAGAN, MINNICH & McKEE, LLP, 7th Floor, 1100 Super Avenue, Cleveland, OH, 44114-2518, US

(21) Appl. No.: 09/794,510

(22) Filed: Feb. 26, 2001

Related U.S. Application Data
(63) Continuation of application No. 09/209,364, filed on Nov. 16, 1998, now abandoned.

(30) Foreign Application Priority Data
Dec. 18, 1997 (HU) P 97 02494

(51) Int. Cl. H01J 5/48

(52) U.S. Cl. 313/318.01

(57) ABSTRACT

The present invention provides a plastic cap (10) for fixing a glass body of a discharge tube of a compact fluorescent lamp in prescribed position by an adhesive material. The plastic cap is suitable for being fixed firmly to a housing of a fluorescent lamp base, and has a front plate (12) closing the inner space of the hollow housing or a part of the hollow housing of the fluorescent lamp base towards the discharge tube. As surface portions positioning the tube ends (34, 36, 38, 40, 42, 44) of the glass body of the discharge tube and fixing particular tube ends (38) firmly by an adhesive joint, seats (14, 16, 18, 20, 22, 24, 26, 28) with closed walls at least partly without perforations are indented into the front plate (12) of the cap (10). The seats (16, 20, 22, 26) only for positioning the tube ends (36) of the glass body have completely closed walls, while the seats (14, 18, 24, 28) also for fixing the tube ends (38) of the glass body by adhesive joint are provided with openings (50, 52, 54) suitable for introducing an adhesive material into the seats (14, 18, 24, 28) from the side of the front plate (12) opposite to the glass body of the discharge tube.

This invention relates to the construction of compact fluorescent lamps, and, more particularly, to a plastic cap structure for connecting such plastic cap with the discharge tube of the compact fluorescent lamp.

From the patent application published under No. T/73090 in No. 6/1996 of the Szabadalmi és Védjegyértesitõ (Hungarian Patent and Trademark Bulletin), constructions for the plastic caps of compact fluorescent lamps are known in which the legs of the glass body of the fluorescent lamp protrude into the inner space defined by the cap and the housing through openings. The glass body is fixed to the cap of the compact fluorescent lamp in the inside portion of the cap, opposite to the discharge tube using a cement or another suitable bonding or adhesive material. As with the adhesive joints generally, the mechanical strength of the glass-to-plastic adhesive joint is highly influenced by the size of the bonded, particularly the parallel adhesion surfaces. Therefore, separate elements with the only function to support the adhesive material are built in the cap. This construction increases the amount of material required for the plastic part, and, at the same time, does not define the space to be filled up with adhesive material sufficiently and thus it does not guide the spread of the adhesive.

It is another feature and also deficiency of other plastic caps that they allow the radiant heat coming from the tube ends containing glowing electrodes to affect adversely the lifetime of the electronic unit located in the housing of some compact fluorescent lamps. In order to decrease this radiated heat, a deflector plate is built in the compact fluorescent lamp as a separate part according to a known solution, but this is disadvantageous due to the additional production cost of the plate as well as to the more complicated assembly process required. Cap constructions in which the heat deflector is an integral part of the cap are also known, but in this case fixing the glass body with an adhesive is problematic.

Thus there is a particular need for a cap construction which gives a safe solution for fixing the glass body in an exactly defined position by an adhesive joint of sufficient mechanical strength. There is also a need for the use of a feasible manufacturing process and saving adhesive material. There is a further need for the reduction of the amount of heat directed towards the inner space of the base.

The present invention is based on the recognition that a cap construction has to be created which is as continuous as possible, i.e. it does possibly not comprise any perforation. This results in sufficient blocking of the heat between the discharge tube and the inner space of the base. The cap construction is also provided with well-defined surface elements forming sufficiently large adhesion surfaces for applying the adhesive material. We have recognized that using the current tool-making and plastic processing technologies, the opportunity is given to construct and manufacture a plastic cap as one single part, i.e. without the need for additional construction elements.

The present invention provides a plastic cap for fixing a discharge tube of a compact fluorescent lamp in prescribed position by a bonding material. The plastic cap is suitable for being fixed firmly to a housing of the fluorescent lamp base. The plastic cap has a front plate closing the inner space of the hollow housing or a part of the hollow housing of the fluorescent lamp base towards the discharge tube. Surface portions are formed on the front plate for positioning at least some of the tube ends of the glass body of the discharge tube having at least one pair of tube ends and optionally also for increasing the mechanical strength of the adhesion joint between the tube ends and the cap. Seats with closed walls at least partly without perforations are as surface portions indented into the front plate of the cap in an arrangement corresponding to the geometry of the glass body of the discharge tube. The seats are fitted to the actual shape of the tube ends of the glass body for positioning the tube ends and also for fixing some of the tube ends by means of adhesion joint. The seats only for positioning the tube ends of the glass body have completely closed walls, while the seats also for fixing the tube ends of the glass body by adhesion joint are provided with openings suitable for introducing an adhesive material into the seats from the side of the front plate opposite to the discharge tube.

This plastic cap construction, due to the seats formed in the front plate and fitted to the particular tube ends, provides well-defined fitting gaps and increased adhesion surfaces ensuring sufficient mechanical strength with saving adhesive material for the plastic-to-metal bonds fixing the particular tube ends of the glass body to the cap. In addition to this, these plastic caps are components of relatively simple construction which do not require the use of complicated manufacturing tools. A uniformly distributed adhesive layer is ensured. The bonding material is allowed to get only to the required places by the openings suitable for introducing a bonding material. It is an additional advantage of these plastic caps that their use in compact fluorescent lamps integral with an electronic unit eliminates the need for an additional heat deflection plate as a separate component. Some seats indented into the front plate of the cap have completely closed walls and the seats with openings are completely closed by the adhesive material which has the consequence that the cap itself provides sufficient protection against the heat.

The features of the present invention will be described in detail in the following by showing an example of the plastic cap in which the invention is embodied, with reference to the figures of the attached drawing. For better understanding, not only the plastic cap itself but also the tube ends of the glass body of the discharge tube in oriented and fixed position are shown in the sectional views of the drawing, in which

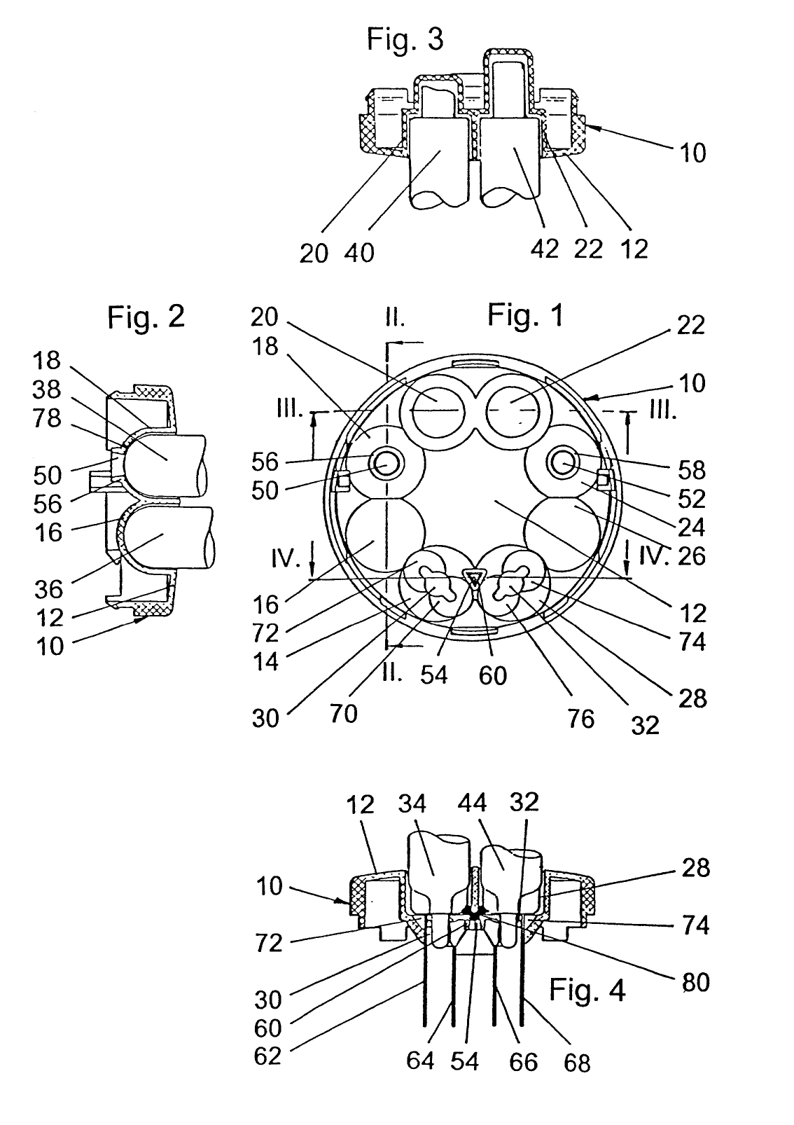

FIG. 1 is a bottom view of the example of the plastic cap in which the invention is embodied,

FIG. 2 is a section of the plastic cap and the corresponding tube ends of the discharge tube of the compact fluorescent lamp connected thereto, taken along plane II.-II. of FIG. 1,

FIG. 3 is a section taken along plane III.-III. of FIG. 1 and

FIG. 4 is a sectional sketch of the plastic cap and the tube ends of the discharge tube fitted to the seats indented into the front plate of the cap, taken along plane IV.-IV. of FIG. 1.

In FIGS. 1 through 4, an example of a plastic cap 10 constructed for a compact fluorescent lamp with a glass body consisting of eight discharge tube legs is seen. The cap 10 is a thin-walled construction element with the shape of a body of rotation which is formed as a cover having a claw-shaped rim. This rim can be fixed firmly to the housing (not shown in the drawing) of a compact fluorescent lamp base wherein the cover has a front plate 12 that separates the inner space of the housing from the light-emitting discharge tube. However, the cap 10 plays not only the role of a cover closing the inner space of the housing of the base, but it also has the very important function of keeping the glass body of a relatively complicated structure in a prescribed position firmly. Of the eight tube ends of the glass body, some tube ends 34, 36, 38, 40, 42 and 44 are only seen in the attached drawing. As a consequence of the construction of the compact fluorescent lamp, the tube ends 34, 36, 38, 40 42 and 44 have different shapes by pairs. It is seen clearly in FIGS. 2 through 4 that the tube ends 36, 38 sectioned by the plane II.-II. have the shape of a hemisphere (see FIG. 2), the tube ends 40, 42 sectioned by the plane III.-III. have exhaust studs of smaller diameter (see FIG. 3), while the tube ends 44 and 34 sectioned by plane IV.-IV. are formed with a so-called pinched end portion ensuring the vacuum-tight feedthrough of metal inleads 62, 64 and 66, 68 of the discharge tube (see FIG. 4). The compact fluorescent lamp provided with the cap 10 has a further constructional feature: the glass body of the discharge tube is fixed to the cap 10 by an adhesive only at tube ends 34, 44, 38 as well as a further tube end which is identical in shape with and is positioned opposite to the tube end 38.

Seats 14, 16, 18, 20, 22, 24 26 and 28 are indented into the front plate 12 of the cap 10. These seats have partly closed walls fitting to the shape of the tube ends 34, 36, 38, 40, 42 and 44 and are arranged corresponding to the geometry of the glass body of the discharge tube. It is clearly seen in the attached drawing that the seats 16 and 18 are hemispherical indentations fitting to the hemispherical-shaped tube ends 36, 38, the seats 20 and 22 have the shape of a stepped cylinder to accept the tube ends 40, 42 with tipped-off exhaust studs, and the shape of the seats 14 and 28 fits to that of the pinched seal of tube ends 34 and 44. The seats 24 and 26 (not shown in section) also have a hemispherical shape, the shape of seat 24 is identical with that of the seat 18, while the seat 26 is shaped in the same way as the seat 16. As mentioned above, due to the construction of the compact fluorescent lamp, each tube leg is not fixed to the cap 10 by adhesion joint. In the example of the embodiment shown in the drawing, the tube ends 36, 40, 42 and the further tube end having the shape identical with that of the tube end 36 (not shown) are not fixed also by adhesive joint in the seats 16, 20 22 and 26. According to characteristic feature of the invention, the seats 16, 20 22 and 26 positioning the tube ends are formed as closed-wall indentations without perforations. At the same time, the tube ends fitted to the seats 14, 18, 24 and 28 are fixed also by adhesion joint. As a consequence of the fact that the seats and the tube ends have identical shapes and are fitted to each other, it is ensured that the surfaces for the adhesion joint are increased compared to the known solutions. It is a further characteristic feature of the invention that each of these seats 14, 18, 24 and 28 is provided with an opening 50, 52 and 60 suitable for introducing the adhesive material from the side of the front plate 12 opposite to the discharge tube.

The openings 50 and 52 of the seats 18 and 24 are through bores formed in the bottom region of the seats, each of which is also provided with a funnel-shaped protrusion 56, 58 narrowing toward the seats 18 and 24 and being formed on the side of the front plate 12 opposite to the discharge tube. The funnel-shaped protrusions 56 and 58 promote the introduction of adhesive material into the region between the seats 18, 24 and the tube ends 38 fitting to them. In order to ensure that a predetermined quantity of the adhesive material fills up a specified region of the fitting gap between the walls of the seats 18, 24 and the corresponding tube ends 38 fitting to them, a bag-like indentation, particularly a slot 78 with a cross-section decreasing gradually from the openings 50, 52 is formed in the surfaces of seats 18 and 24. Due to this solution, the predetermined quantity of the adhesive material pushed through the openings 50, 52 fills up completely the spaces confined by the slots 78 and provides well-defined adhesion surfaces for the plastic-to-glass bonds produced with the adhesive material. This results in an always equal bonding strength and even saving of adhesive material.

Differently from the above and seen clearly in FIG. 4, a common opening 54 for introducing the adhesive material is formed for the adjacent seats 14 and 28. The opening 54 extending into both seats 14 and 28 and is also provided with a funnel-like protrusion 60 on the side of the front plate 12 opposite to the discharge tube. This funnel-like protrusion 60 promotes the introduction of the adhesive material. In this way, a predetermined quantity of the adhesive material pushed through the opening 54 produces a firm adhesive joint 80 between the glass body and the cap 10. This joint 80 firmly fixes the tube ends 34 and 44 in the seats 14 and 28, respectively. It is also seen in FIGS. 1 and 4 that the bottom regions of the seats 14 and 28 are also provided with bores 30, 32 passing through the inleads 62, 64 and 66, 68. In these regions, funnels 70, and 74, 76 are formed which start from the seats 14, 28, have a cross-section conically decreasing toward the inlead-passing bores 30, 32 and guide inleads 62, 64, and 66, 68 into the corresponding bores 30, 32 during assembly.

The solution according to the invention and the preferable provisions thereof not limited to the exemplary embodiment shown above. The plastic caps accomplishing the objectives and providing the advantages of the invention can be constructed for compact fluorescent lamps with less or more tube ends in different arrangements and optionally with different shapes and end seals. Thus, within the scope of protection defined by the attached claims, several further embodiments and alternatives can be constructed for compact fluorescent lamps built differently and identically.

1. A plastic cap for fixing a glass body of a discharge tube of a compact fluorescent lamp in prescribed position by a bonding material, the cap is suitable for being fixed firmly to a housing of a fluorescent lamp base and has a front plate closing the inner space of the hollow housing or a part of the hollow housing of the fluorescent lamp base towards the discharge tube; and surface portions are formed on the front plate for positioning at least some of the tube ends of the glass body of the discharge tube having at least one pair of tube ends and optionally also for increasing the mechanical strength of the adhesion joint between the tube ends and the cap wherein seats (14, 16, 18, 20, 22, 24, 26, 28) with closed walls at least partly without perforations are as surface portions indented into the front plate (12) of the cap (10) in an arrangement corresponding to the geometry of the glass body of the discharge tube, the seats are fitted to the actual shape of the tube ends (34, 36, 38, 40, 42, 44) of the glass body for positioning the tube ends (34, 36, 38, 40, 42, 44) and also for fixing at least some of the tube ends (34, 38, 44) by means of adhesion joint; the seats (16, 20, 22, 26) only for positioning the tube ends (36, 40, 42) of the glass body have completely closed walls, while the seats (14, 18, 24, 28) also for fixing the tube ends (34, 38, 44) of the glass body by adhesion joint are provided with openings (50, 52, 54) suitable for introducing an adhesive material into the seats (14, 18, 24, 28) from the side of the front plate (12) opposite to the discharge tube.

2. The plastic cap of claim 1 in which at least one bag-like indentation, particularly a slot (78) is also formed in the surface of some seats (18, 24) fitting to the tube end (38), in the vicinity of the openings (50, 52).

3. The plastic cap of claim 2 in which the bag-like indentation (78) has a cross-section gradually decreasing from the opening (50, 52).

4. The plastic cap of claim 1 in which the bottom regions of some seats (14, 28) being adjacent to each other are also provided with at least one bore (30,32) for feeding through inleads of the discharge tube ends.

5. The plastic cap of claim 4 in which inlead-guiding funnels (70, 72, 74, 76) with diameters decreasing towards the bores (30,32) are formed in the bottom regions of the seats (14, 28) with bores (30, 32).

6. The plastic cap of claim 4 in which the adjacent seats (14, 28) with bores (30, 32) are provided with a common opening (54) formed for introducing an adhesive material, the common opening (54) extends into both seats (14, 28) simultaneously.

7. The plastic cap of claim 1 in which each opening (50, 52, 54) suitable for introducing an adhesive material is also provided with a funnel-like protrusion (56, 58, 60) being formed on the side of the front plate (12) opposite to the discharge tube and having cross-section narrowing towards the corresponding seat (14, 18, 24, 28).
